(19) United States
(12) Patent Application Publication
(10) Pub. No.: US 2016/0090765 A1
(43) Pub. Date: Mar. 31, 2016

(54) ANTI-LIGATURE MECHANISM

(71) Applicant: Gary Abell, Manchester, Greater Manchester (GB)

(72) Inventor: Gary Abell, Failsworth (GB)

(21) Appl. No.: 14/890,267

(22) PCT Filed: May 7, 2014
(86) PCT No.: PCT/GB2014/051394

§ 371 Date: Nov. 10, 2015

(30) Foreign Application Priority Data
May 10, 2013 (GB) 1308400.9

(51) Int. Cl. E05D 7/10; E06B 7/28; E05D 7/12

(52) U.S. Cl. CPC E05D 7/1011; E05D 7/12; E06B 7/28

(57) ABSTRACT

An apparatus for facilitating movement of a closure (20) away from a part of a support (22,24) for the closure (20), the apparatus comprising: a bias component (26) engageable with the support (22,24) and closure (20); and an engagement component (28) engageable with said support (22,24) and closure (20); the bias component (26) when in a first state being arranged to bias a part of said closure (20) into engagement with a part of the engagement component (28) and to retain the closure (20) relative to that part of the engagement component (28), and the bias component (26) when in a second state, in which the bias is at least partially overcome, facilitating at least partial disengagement of the closure (20) from the part of the engagement component (28), to allow the closure (20) to be moved away from that part of the engagement component (28).

The present invention relates, in one example embodiment, to an anti-ligature mechanism. However, the principles associated with that mechanism may be used more broadly, and may relate to methods, assemblies and apparatus for use in conjunction with a closure and a support for the closure.

It is an unfortunate fact that people sometimes choose to take their own lives by hanging themselves. In an environment where there might be a perceived increased risk of somebody wishing to, or likely to, hang themselves, the environment may in some way be modified to reduce the chances of someone being able to successfully hang themselves. In particular, closures may be modified to reduce this risk, for example by making a modification to a door to a room, or a door to a wardrobe, or a door to a shower, or similar. One such modification might involve the provision of a chamfer at an upper corner of the closure, remote from a hinge or pivot point of the closure. This chamfer prevents a length of material being fixedly, or substantially fixedly, attached to the top of the closure, from which hanging might be attempted. The chamfer is provided in an attempt to ensure that the length of material simply slides off the top of the closure.

Although the use of a chamfered closure may at least partially reduce the risk of attempted hanging, and may therefore serve as an anti-ligature arrangement or configuration, there are still disadvantages associated with the configuration. One disadvantage is that chamfering of the closure might also require appropriate shaping of the support for the closure, such as a frame or wall, for example for aesthetic or functional reasons. Alternatively and/or additionally, the use of a chamfer may only serve to reduce the risk of hanging when the length of material used in the hanging attempt is to be secured at an edge of the closure remote from the hinge or similar. If material is moved further towards the hinge, the chamfer may no longer offer any benefit.

It is this an example aim of examples embodiments of the present invention to at least partially obviate or mitigate one or more disadvantages of the prior art, whether identified herein or elsewhere, or to provide an alternative to existing methods, assemblies and apparatus.

According to the present invention there is provided a method, assembly and apparatus as set forth in the appended claims. Other features of the invention will be apparent from the dependent claims, and the description and Figures that follow.

According to a first aspect of the present invention, there is provided a method of facilitating movement of a closure away from a part of a support for the closure, the method comprising: overcoming a bias of a bias component engaged with the closure and support, in order to bring the closure out of engagement with a part of an engagement component that is attached to or forms part of the support; and moving, or allowing movement of, the closure away from the part of the engagement component.

According to a second aspect of the present invention, there is provided a method of retaining a closure relative to a support for the closure, the method comprising: overcoming a bias of a bias component engaged with the closure and support, to facilitate bringing the closure into engagement with a part of an engagement component that is attached to or forms part of the support in order to retain the closure relative to that part of the engagement component; and allowing the bias component to bias the closure into engagement with the part of the engagement component.

According to a third aspect of the present invention, there is provided an assembly for use with a closure and a support for the closure, the assembly comprising: a bias component engageable with said support and closure; and an engagement component engageable with said support and closure; the bias component when in a first state being arranged to bias a part of said closure into engagement with a part of the engagement component and to retain said closure relative to that part of the engagement component, and the bias component when in a second state, in which the bias is at least partially overcome, facilitating at least partial disengagement of said closure from the part of the engagement component, to allow said closure to be moved away from that part of the engagement component.

According to a fourth aspect of the present invention, there is provided apparatus for facilitating movement of a closure away from a part of a support for the closure, the apparatus comprising: a bias component engageable with the support and closure; and an engagement component engageable with said support and closure; the bias component when in a first state being arranged to bias a part of said closure into engagement with a part of the engagement component and to retain the closure relative to that part of the engagement component, and the bias component when in a second state, in which the bias is at least partially overcome, facilitating at least partial disengagement of the closure from the part of the engagement component, to allow the closure to be moved away from that part of the engagement component.

The engagement component may, when engaged with the closure due to bias of the bias component, be configured to retain the closure relative to the engagement component, and also to allow for movement of the closure relative to the engagement component. Movement may be hinge-like in nature.

The bias component may be arranged, in use, to bias the closure in an upwards direction.

The engagement component may comprise a notch or protrusion or similar for mating engagement with a corresponding protrusion or notch or similar attached to or forming part of the closure, the biasing of the bias component being surmountable to engage or disengage the protrusion or notch of the closure with the notch or protrusion of the engagement component.

The engagement component may comprise a closed-end guide for, when the biasing is overcome, guiding movement of the closure, while retaining the closure relative to the guide.

The bias component may comprise an element that engages with a recess in the closure, or the bias component may comprise an element that engages with a recess in the support.

A bias component engager may be provided that is at least partially located or locatable within a recess of the door, and arranged to engage with the bias component, the bias component engager comprising: a first part fixed or fixable at least partially within the recess; a second part moveable relative to the first part to facilitate at least partial disengagement of the closure from the part of the engagement component; wherein before, during and/or after relative sliding of the first and second parts, one of the first part and second part at least partially surrounds the other of the first and second part.

The bias component may be arranged to facilitate at least pivotal-like motion of the closure away from the support when the biasing of the bias element has been overcome.

The degree of biasing provided by the bias component may be selectively adjustable.

The bias component may comprise a spring.

The bias component may be attached to one or both of the support and the closure. The engagement component may be attached to one or both of the support and the closure.

An indicator may be provided that is arranged to audibly and/or visually indicate when the biasing of the bias component has been overcome to an extent that facilitates disengagement of part of said closure from the part of the engagement component.

The engagement component and bias component may be located at substantially opposite ends of the closure.

The closure may be one or more of a door, a window, or at least a part of a hinge.

The support may be one or more of, or a combination of: a wall, a floor, and/or a frame of the closure.

The support may be shaped to, in use, provide a space below the closure, so that the closure can move in to that space to allow said closure to be moved away from the part of the engagement component.

One or more features of one or more aspects or embodiments of the invention may, where apparent to the skilled person from a reading of this disclosure as a whole, be used in combination with and/or in place of one or more features of one or more other aspects or embodiments of the invention.

For a better understanding of the invention, and to show how embodiments of the same may be carried into effect, reference will now be made, by way of example, to the accompanying diagrammatic Figures in which:

FIG. 1 schematically depicts a closure and a support for that closure;

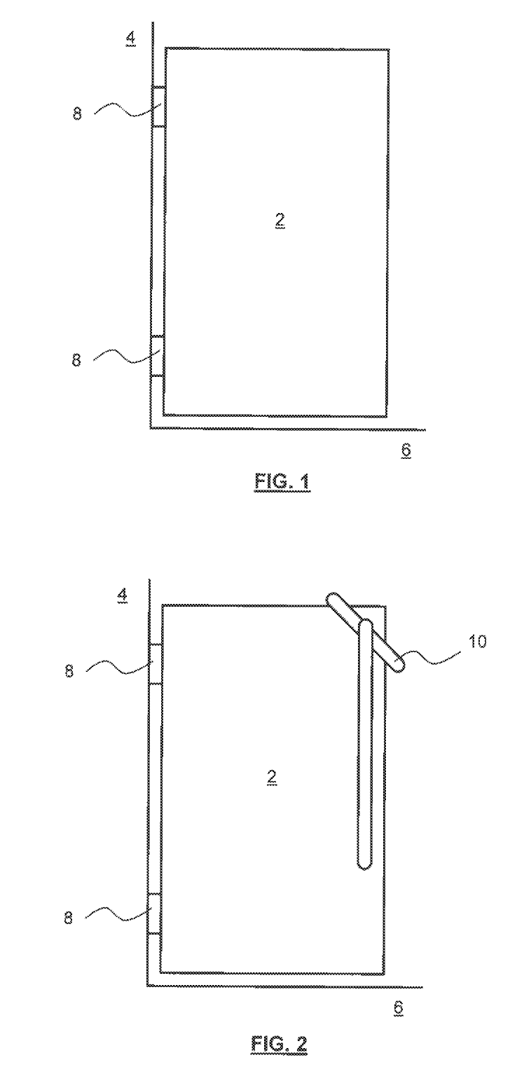

FIG. 2 schematically depicts the closure and support of FIG. 1, in combination with a length of material that might be used in an attempted hanging;

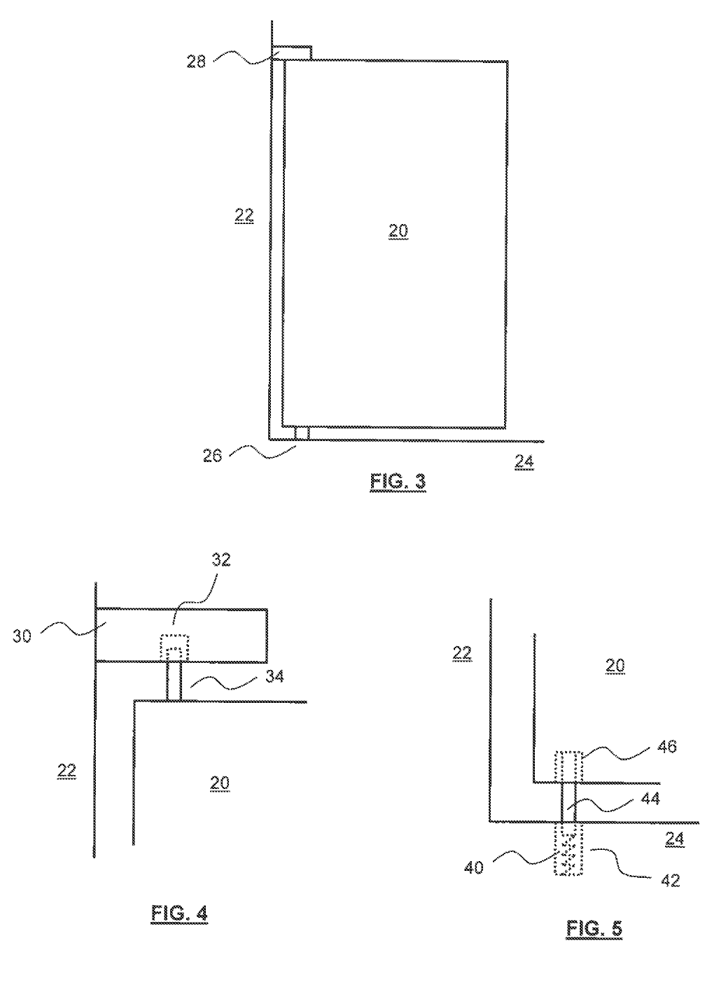

FIG. 3 schematically depicts a closure and a support, and an assembly for use with that closure and support, in accordance with an example embodiment of the present invention;

FIG. 4 schematically depicts detail of the engagement component of the assembly of FIG. 3;

FIG. 5 schematically depicts detail of a bias component of the assembly of FIG. 3;

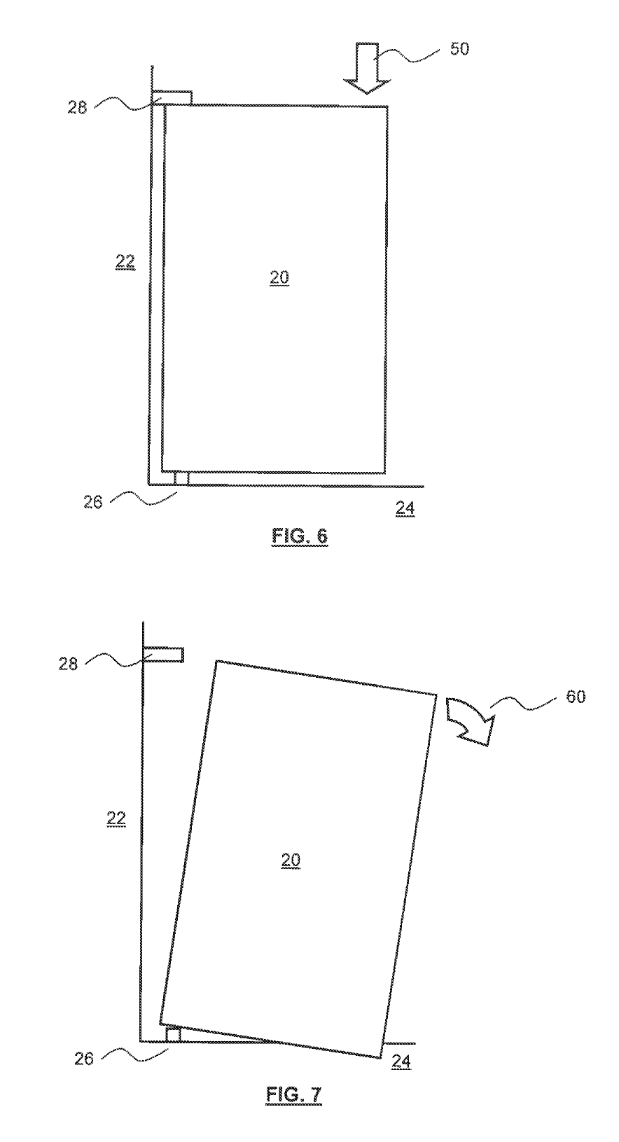

FIGS. 6 and 7 schematically depict general principles associated with the use of the assembly of FIGS. 3 to 5;

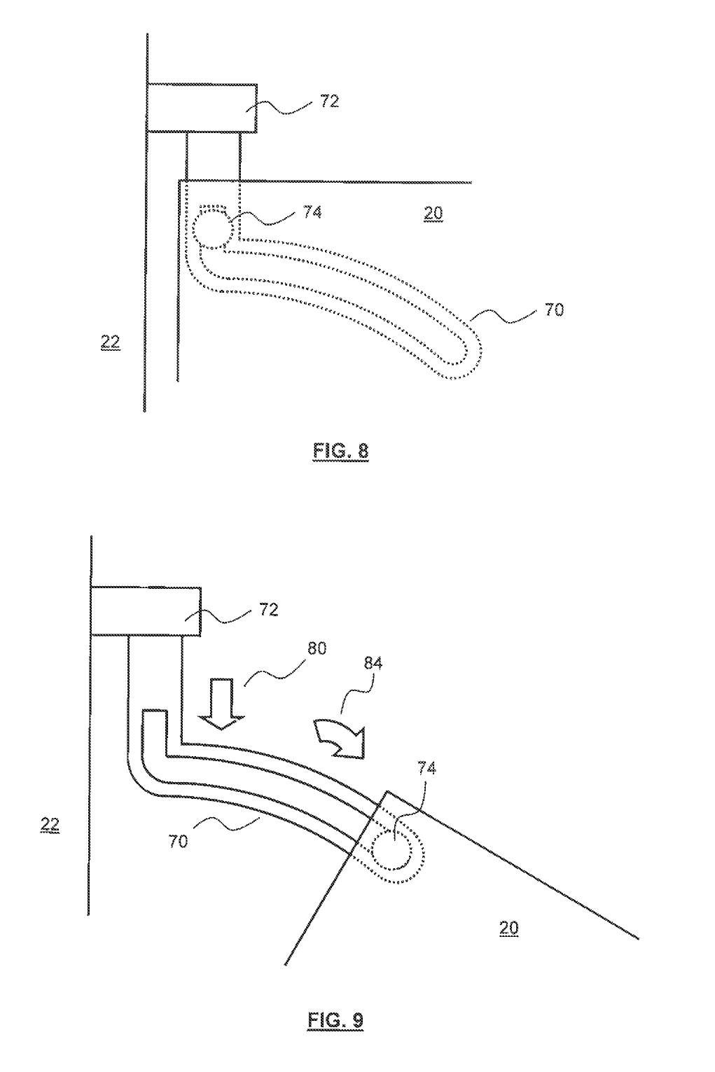

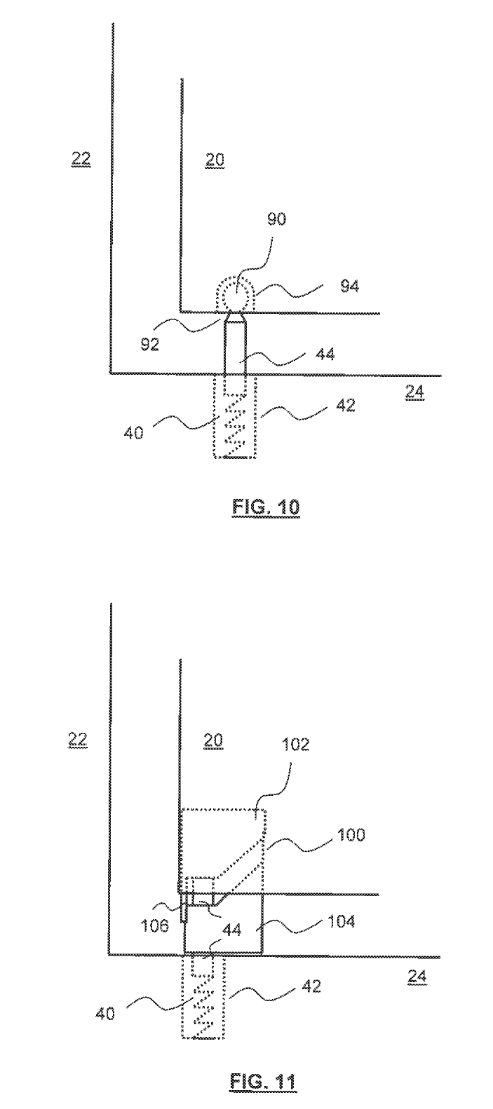

FIGS. 8 and 9 schematically depict a variation on the assembly of FIG. 3, comprising a closed-end guide for guiding movement of the closure in certain circumstances;

FIG. 10 schematically depicts a variation on the bias component of FIG. 5; and

FIG. 11 schematically depicts a further variation on principles of the bias component shown in and described with reference to FIG. 5.

FIG. 1 schematically depicts a closure (2) in the form of a door (2). The door (2) is shown in relation to a support, which takes the combined form of a wall (4) and a floor (6). The door (2) is attached to the wall (4) via conventional hinges (8).

FIG. 2 shows that a length of material (10) has been hooked over an upper end of the door (2), remote from the hinge (8). The length of material (10) may be used by a person to attempt to commit suicide by hanging. A right angle of the door (2) over which the length of material (10) is hooked substantially prevents the length of material (10) from slipping over and off the upper surface of the door (2) and falling off the door (2). Thus, the risk of successful hanging is not reduced when such a right angle is present. As discussed above, even if the right angle is replaced with a chamfer or similar, risks still remain.

According to an example embodiment of the present invention, the above mentioned problems can be at least partially obviated or mitigated.

In one instance, the present invention provides an assembly for use with a closure and support for the closure. The assembly comprises a bias component engageable with said support and closure, and an engagement component engageable with said support and closure. The bias component when in a first state is arranged to bias a part of said closure into engagement with a part of the engagement component, and to retain said closure relative to that part of the engagement component with that biasing. The bias component when in a second state, in which the bias is at least partially overcome, facilitates at least partial disengagement of said closure from the part of the engagement component, to allow said closure to be moved away from that part of the engagement component. The assembly may be used in reverse, to allow for retaining of the closure relative to the support.

In accordance with the general principles described above, and in accordance with an example embodiment, a person may attempt to hang themselves by hooking a length of material over an end of the closure. Initially, the closure is biased into engagement with a part of the engagement component by the bias component, for example a spring or similar, and the closure is thus retained relative to that part of the engagement component. If and when the person attempts to hang themselves using the length of material, a resulting increased load on the closure causes the bias on the bias component to be at least partially overcome or surmounted. As a result, the closure is at least partially disengaged from the part of the engagement component, and this allows the closure to move away from that part of the engagement component, for example resulting in the door simply being removed from the support in its entirety, or being removed to a sufficient extent or orientation which results in it being more difficult or impossible for users to successfully hang themselves.

FIGS. 3 to 11 will now be used, by way of example only, to describe example embodiments of the present invention.

FIG. 3 schematically depicts a closure (20) relative to a combined support for that closure in the form of a wall (22) and floor (24). The closure (20) is engaged or otherwise attached to the wall (22) and/or floor (24) by way of the above mentioned assembly, in the form of a bias component (26) and an engagement component (28).

FIG. 4 schematically depicts detail of the engagement component. The engagement component, in this embodiment, comprises a bracket or similar (30). The bracket (30) comprises a notch or recess (32) for mating engagement with a corresponding protrusion attached to or forming part of the closure (20).

FIG. 5 schematically depicts details of the bias component. In this embodiment, the bias component comprises a spring (40) located in a recess (42) of the floor (24). A rod element or similar (44) is attached to or is engagement with the spring (40), and is provided to reside at least partially within a recess (46) of the closure (20).

Referring to FIGS. 4 and 5 in combination, the assembly as a whole is configured, as discussed above, to ensure that the bias component biases the closure (20) in an upward direction, into engagement with the engagement component. When engaged, the engagement component and bias component are, together, configured to retain the closure relative to the engagement component and thus wall (22), and also to allow for movement of the closure (20) relative to the engagement component and thus wall (22), for example in a hinge-like manner. The biasing will be sufficient to overcome the weight of the door, whilst at the same time not being so high as to undergo insignificant or negligible movement or compression when the load of a person is applied downwardly through the closure (20).

FIG. 6 shows a load (50) being applied to an end of the closure (20) remote from the engagement component (28). The load (50) might, for instance, signify or indicate a load that might be applied if a person attempted to hang themselves using the closure (20). FIG. 7 shows that, as a result of the assembly described in relation to FIGS. 3 to 5, the closure (20) disengages with the engagement component (28) and moves and falls away from the wall (22) as indicated by arrow (60). Hanging is no longer possible.

Although the embodiments described above are advantageous, there is a disadvantage. A disadvantage is that the closure (20) becomes detached from and free from the assembly as described. In certain unfortunate circumstances, the closure (20) could then be used as a weapon, and this is undesirable. FIGS. 8 and 9 show how this problem may be overcome, in accordance with an example embodiment.

In FIG. 8, a variation on the engagement component is shown. The engagement component now comprises a closed-end guide (70) for, when the biasing of the bias component is overcome, guiding movement of the closure (20), whilst at the same time retaining the closure (20) to the guide (70).

The guide (70) may be attached to the wall (22) via a bracket or similar (72). The guide (70) itself may be located alongside the closure (20), or, as shown in the Figures, be locatable within a recess of the closure (20). The closure (20) may engage, co-operate and/or be guided by the guide (70) by way of a protrusion (74) that extends from the closure (22) and through the guide (70). The protrusion (74) might have a flared portion on an opposite side of the guide (70), to prevent easy disengagement of the protrusion (74) from the guide (70).

FIG. 9 shows how the embodiment may work in practice. A first arrow (80) shows how a load may be applied to the closure (20) to disengage the protrusion (74) of the closure (20) from a notch (82) of the guide (70). Once removed from the notch (82), the closure (20) falls under its own weight, and/or the previously mentioned load, away from the wall (22) as indicated by arrow (84). However, the embodiment ensures that the falling is guided by guide (70) and limited by the closed-end nature of the guide (70). Thus, the arrangement shown in FIGS. 8 and 9 still prevents someone from hanging themselves using the closure (20), while at the same time preventing the closure (20) being removed from the described assembly for use as a weapon or similar. Alternatively and/or additionally, the same arrangement allows the assembly as a whole to be reset relatively easily, so that the door may be used as usual simply by reversing the process shown in and described with reference to FIG. 9.

As already discussed above, when disengaged from the engagement component, the door will fall away from the engagement component. FIG. 10 shows how the bias component may be better tailored to facilitate this movement of the door. FIG. 10 is a modification of the bias component already shown in and described with reference to FIG. 5. In FIG. 10, the end of the rod element or similar (44) that engages with the closure (20) is more rounded (90) in nature, and may be attached to a remainder of the element (44) by a thinner neck (92). A recess (94) within the door (20), for receiving the rounded end (90), may also be more rounded. As a result, the arrangement as a whole now more readily facilitates at least substantially pivotal-like motion of the closure (20) when disengaged from the engagement component relative to the bias component as a whole, or at least the rod element or protrusion (44) thereof.

Even though embodiments of the present invention may prevent, or at least reduce the risks of, someone hanging themselves using a closure, a person may still attempt to hang themselves from a part of the assembly, and in particular the bias component. That is, an attempt may be made without using the closure itself. To this end, an embodiment of the present invention makes it more difficult to do this. FIG. 11 shows that the assembly might alternatively and/or additionally comprise a bias component engager that is at least partially located or locatable within a recess (100) of the closure (20). The bias component engager may comprise a first part (102) that is fixed or fixable at least partially within the recess (100). A second part (104) is also provided, the second part being slidable relative to the first part (102). The sliding is to facilitate the at least partial disengagement of the closure as a whole from the part of the engagement component as described above. In another example, sliding may not be required, and any suitable motion may suffice, for example sliding, hinging, pivoting, or a combination thereof. Hinging or pivoting may facilitate the pivot like motion of the closure discussed above, for example as exemplified in relation to FIG. 10.

Referring back to FIG. 11, before, during and/or after relative sliding of the first and second parts (102, 104), one of the first part (102) and second part (104) at least partially surrounds (106) the other of the first part (102) and second part (104). The surrounding (which might be described as sheathing or enveloping) is so that it is more difficult for a length of material to, for instance, be located in, amongst, and/or around the bias component, for example a rod element (44) thereof, or similar.

In the embodiment shown, the sliding and biasing may be facilitated in one of a number of different ways. In once instance, the rod element (44) or similar may be attached to the first part (102), and be slidable within a bore or similar in the second part (104) for engagement and biasing by the spring (40). In another embodiment, not shown, the spring may be located within the first component, and the rod element could be attached to the second part (104) that might ride on or in some other way engage with a support such as a floor. In short, any arrangement that allows for the biasing and relative movement may be used, so long as that before, during and/or after relative movement of the first and second parts, one of the first part and second part at least partially surrounds the other of the first part and second part.

As already alluded to above, the biasing provided by the bias component may be selected or selective, for facilitating ready disengagement of the closure from the engagement component with a suitable load on the closure. The selection may be achieved by using springs of different stiffness, or by providing an adjustable spring or other biasing arrangement. For instance, the biasing can be achieved such that the biasing can only be overcome to an extent to facilitate such disengagement when a load of a particular magnitude is placed on the closure. That magnitude might be, for example, a weight of the closure plus substantially that of an average person, or a weight of the closure plus substantially that weight of a specific person using a room or similar in which the closure is located.

Although not shown in the Figures, the assembly might further comprise an indicator that audibly and/or visually indicates when the biasing of the biased component has been overcome to an extent that facilitates disengagement of the part of the closure from the part of the engagement component. For instance, this may alert a third party as to the disengagement, which might equate to a potential suicide attempt or similar. The indicator can work in any appropriate manner. In one instance, the indicator might comprise contacts at the engagement component that are kept in contact with one another when the closure is engaged with the engagement component. Breaking of the contacts might trigger the indicator.

In the embodiments, the engagement component and bias component are shown as being located at substantially opposite ends of the closure. This may facilitate installation, maintenance, resetting, or the like of the entire arrangement. However, in other embodiments the bias component and engagement component could be located on the same side of the closure, for example taking the same location as conventional hinges or similar. Indeed, the bias component and/or the engagement component could at least take the form of part of a hinge used to attach a door or similar to a support. In this case the or each hinge or part thereof might be described as being the closure. In another instance, the or each hinge, or part thereof, might be described as being, comprising or constituting the engagement component or the bias component.

In the embodiments described above, the closure is shown as moving away from and falling away from the support. The support itself may be intentionally shaped to provide a space below the closure. This allows the closure to move, or more readily move, into that space to allow the closure to be disengaged from the engagement component as and when necessary. In another example, the mounting of the closure relative to the support may ensure that such a space is provided.

The support has been described above as a wall and, in combination, a floor. The support can be anything that might support the closure, and for example might be a frame, a wall, a floor, or a combination thereof.

Any engagement described herein could be a mating engagement, or an abutment-like engagement, or a combination thereof.

The invention has been described above in relation to its use as an anti-ligature mechanism. However, the very same principles may be used as a very convenient way of, for instance, installing and un-installing closures in general. For instance, the present invention provides a relatively quick and easy way of installing a door such that it is biased toward and retained with the above mentioned engagement component. Similarly, and furthermore, the door may be, selectively, disengaged and removed from the support in much the same way as has been described above, by application of an appropriate load. Thus, the invention might find greater and wider use than as an anti-ligature mechanism.

Although a few preferred embodiments have been shown and described, it will be appreciated by those skilled in the art that various changes and modifications might be made without departing from the scope of the invention, as defined in the appended claims.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method of facilitating movement of a closure away from a part of a support for the closure, the method comprising:
overcoming a bias of a bias component engaged with the closure and support, in order to bring the closure out of engagement with a part of an engagement component that is attached to or forms part of the support; and
moving, or allowing movement of, the closure away from the part of the engagement component.

2. A method of retaining a closure relative to a support for the closure, the method comprising:
overcoming a bias of a bias component engaged with the closure and support, to facilitate bringing the closure into engagement with a part of an engagement component that is attached to or forms part of the support in order to retain the closure relative to that part of the engagement component; and
allowing the bias component to bias the closure into engagement with the part of the engagement component.

3. An assembly for use with a closure and a support for the closure, the assembly comprising:
a bias component engageable with said support and closure; and
an engagement component engageable with said support and closure;
the bias component when in a first state being arranged to bias a part of said closure into engagement with a part of the engagement component and to retain said closure relative to that part of the engagement component, and
the bias component when in a second state, in which the bias is at least partially overcome, facilitating at least partial disengagement of said closure from the part of the engagement component, to allow said closure to be moved away from that part of the engagement component.

4. The assembly according to claim 3, wherein said assembly facilitates movement of a closure away from a part of said support for the closure.

5. The assembly of claim 3, wherein the engagement component is, when engaged with the closure due to bias of the bias component, configured to retain the closure relative to the engagement component, and also to allow for movement of the closure relative to the engagement component.

6. The assembly of claim 5, wherein movement is hinge-like in nature.

7. The assembly of claim 3, wherein the bias component is arranged, in use, to bias the closure in an upwards direction.

8. The assembly of claim 3, wherein the engagement component comprises a notch or protrusion for mating engagement with a corresponding protrusion or notch attached to or forming part of the closure, the biasing of the bias component being surmountable to engage or disengage the protrusion or notch of the closure with the notch or protrusion of the engagement component.

9. The assembly of claim 3, wherein the engagement component comprises a closed-end guide for, when the biasing is overcome, guiding movement of the closure, while retaining the closure to the guide.

10. The assembly of claim 3, wherein the bias component comprises an element that engages with a recess in the closure, or the bias component comprises an element that engages with a recess in the support.

11. The assembly of claim 3, further comprising a bias component engager at least partially located or locatable within a recess of the door, and arranged to engage with the bias component, the bias component engager comprising:
a first part fixed or fixable at least partially within the recess;
a second part moveable relative to the first part to facilitate at least partial disengagement of the closure from the part of the engagement component;
wherein
before, during and/or after relative sliding of the first and second parts, one of the first part and second part at least partially surrounds the other of the first and second part.

12. The assembly of claim 3, wherein the bias component is arranged to facilitate at least pivotal motion of the closure away from the support when the biasing of the bias element has been overcome.

13. The assembly of claim 3, wherein the degree of biasing provided by the bias component is selectively adjustable.

14. The assembly of claim 3, wherein the bias component comprises a spring.

15. The assembly of claim 3, wherein the bias component is attached to one or both of the support and the closure.

16. The assembly of claim 3, further comprising an indicator that audibly and/or visually indicates when the biasing of the bias component has been overcome to an extent that facilitates disengagement of part of said closure from the part of the engagement component.

17. The assembly of claim 3, wherein the engagement component and bias component are located at substantially opposite ends of the closure.

18. The assembly of claim 3, wherein the closure is a door, a window, or at least a part of a hinge.

19. The assembly of claim 3, wherein the support is one or more of, or a combination of: a wall, a floor, a frame of the closure.

20. The assembly of claim 3, wherein the support is shaped to, in use, provide a space below the closure, so that the closure can move in to that space to allow said closure to be moved away from the part of the engagement component.

21. (canceled)
